(19) United States
(12) Patent Application Publication
(10) Pub. No.: US 2025/0349926 A1
(43) Pub. Date: Nov. 13, 2025

(54) BATTERY MODULE

(71) Applicant: Robert Bosch GmbH, Stuttgart (DE)

(72) Inventors: Markus Schmitt, Tamm (DE); Ralph Glemser, Brackenheim (DE)

(21) Appl. No.: 19/194,259

(22) Filed: Apr. 30, 2025

(30) Foreign Application Priority Data
May 7, 2024 (DE) 10 2024 204 298.6

(51) Int. Cl. H01M 10/653; H01M 10/04; H01M 50/209; H01M 50/224; H01M 50/588

(52) U.S. Cl. CPC H01M 10/653; H01M 10/0468; H01M 50/224; H01M 50/588; H01M 50/209

(57) ABSTRACT

A battery module includes a plurality of prismatically configured battery cells (2), which together form a cell stack (4), and which are accommodated in a housing (3) of the battery module (1). An electrical insulation element (7) is arranged on a battery cell (2) at least on a bottom surface (61) of the battery cell (2) and partially on opposite lateral surfaces (62) of the battery cell (2) in such a way that the electrical insulation element (7) is arranged between the respective battery cell (2) and the housing (3), as well as between the respective battery cell (2) and battery cells (26) adjacent to the battery cell (2). A thermal compensation material (9) is arranged between the battery cell (2) and the housing (3).

### BACKGROUND

The invention is based on a battery module.

Provided is a battery module comprising a plurality of individual battery cells, each of which has a positive voltage tap and a negative voltage tap, wherein the respective voltage taps are connected to each other in an electrically conductive manner for an electrically conductive serial and/or parallel connection of the plurality of battery cells to each other and can thus be interconnected to form the battery module. In particular, the battery cells can each have a first voltage tap, in particular a positive voltage tap, and a second voltage tap, in particular a negative voltage tap, which are connected to each other in an electrically conductive manner by means of cell connectors so that an electrically serial and/or parallel connection is formed. Battery modules are themselves in turn interconnected into batteries or entire battery systems.

Due to chemical conversion processes, the interiors of lithium-ion battery cells or lithium polymer battery cells heat up, primarily during rapid energy delivery or absorption in battery systems. The more powerful the battery system is, the greater its heating, thus resulting in the need for an efficient active thermal management system.

In particular, liquid temperature control can be used for this purpose, for example with a mixture of water and glycol. The liquid can be directed through channels arranged in a housing of the battery module or in a cooling plate. The liquid temperature control can be connected to a cooling circuit with additional components.

As is known, the battery cells are cooled through their cell bottom, wherein the heat flow passes through the cell bottom into the housing of the battery module or cooling plate. A thermal compensation material can be arranged between the cell bottom of the battery cells and the housing or the cooling plate.

The prior art in this respect includes, for example, the publications DE 10 2020 201 139 and DE 10 2020 210 202.

### SUMMARY

The advantage of a battery module having the features of the independent claim is a design reliably providing a minimum distance between a battery cell of a plurality of battery cells of the battery module and a housing of the battery module, so that an electrical insulation is ensured. In particular, the thermal resistance and electrical insulation can be connected in parallel to each other so that, despite smaller cooling surfaces compared to those known from the publication DE 10 2010 021 148 for cooling pouch cell battery arrangements, reliable cooling can be designed and ensured. A reliable mechanical and thermal connection can be formed with a comparatively large connection surface.

In accordance with the invention, a battery module is provided for this purpose. The battery module comprises a plurality of prismatically formed battery cells, which together form a cell stack and which are accommodated in a housing of the battery module. An electrical insulation element is arranged on each battery cell at least on a bottom surface of the battery cell and partially on opposite lateral surfaces of the battery cell in such a way that the electrical insulation element is arranged between the respective battery cell and the housing, as well as between the respective battery cell and the battery cells adjacent to the battery cell. A thermal compensation material is arranged between the battery cell and the housing.

At this point, it should be noted that prismatically formed battery cells each comprise a battery cell housing with a total of six lateral surfaces, which are arranged in pairs opposing each other and essentially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface. In this case, the plurality of battery cells can be electrically connected in parallel and/or in series by means of cell connectors.

In contrast to designs known from the prior art, in which an adhesive and/or a thermal compensation material is usually arranged between the plurality of battery cells of the battery module and the housing of the battery module, which comprises thermally conductive particles that are electrically non-conductive, imperfections in the housing of the battery module cannot impair the electrical insulation. The size of the thermally conductive particles is intended to ensure a minimum distance in the known designs, which ensures electrical insulation. However, defects on or in the housing, e.g. due to fire cracks and/or unfavorably selected tolerances, can result in locally smaller distances between the plurality of battery cells and the housing, as a result of which the electrical insulation is not reliably formed and electrical contact may be formed between the plurality of battery cells and the housing. This can lead to leaks in the housing of the respective battery cell and also to failure of the entire battery. Furthermore, force effects on the plurality of battery cells when joining the housing and/or when welding the plurality of cell connectors could be used to locally limit very high surface pressures between the bottom of the battery cell and the housing of the battery module, which ultimately lead to the fact that a minimum distance cannot be guaranteed.

It is advantageous when the plurality of battery cells are arranged with their largest lateral surfaces adjacent to each other in a longitudinal direction of the battery module. In an adjacent arrangement of the battery cells in a longitudinal direction of the battery module, the battery cells are arranged adjacent to one another by way of their respective largest lateral surfaces, which are in particular each arranged perpendicular to the upper lateral surface and to the lower lateral surface. It should at this point be noted that the longitudinal direction of the battery module is in this case accordingly arranged perpendicular to the largest lateral surfaces of the battery cells. This has the particular advantage of allowing the battery module to be designed in a compact way.

Furthermore, spacer elements may also be arranged preferentially between each two battery cells arranged adjacent to one another. It is also possible that end plates may be arranged adjacent to the two battery cells arranged terminally, wherein a spacer element is also arranged preferentially between each of the end plates and the battery cells arranged terminally.

In addition, it is also preferred if the plurality of battery cells are tensioned together. In particular, such tensioning can be achieved using tensioning straps. Preferably, the battery module can have two tensioning straps, which are each arranged on one longitudinal side of the cell stack and which are connected to the end plates arranged at the ends. The connection of the tensioning straps to the end plates in this way can preferably be designed to be materially locked. Furthermore, a further thermal compensation material can be arranged between the tensioning straps and the battery cells of the cell stack, so that the heat distribution between the battery cells can be improved. Overall, this can form a comparatively stable and rigid cell stack, which can preferably be inserted into the housing of the battery module as a single unit.

According to a particularly preferred aspect of the invention, the electrical insulation element is further arranged on another lateral surface of the battery cell, such that the electrical insulation element is arranged between the battery cell and a tensioning element of the battery module, specifically a tensioning strap. At this point, it should be noted that the other lateral surface can be specifically referred to as an end face. This provides the particular advantage that the tensioning element and the battery cell can be spaced apart from each other in a defined manner.

Furthermore, it is also particularly preferred if the electrical insulation element has an opening. An additional thermal compensation element is arranged in the opening between the battery cell and the tensioning element. This offers the particular advantage that a defined distance can be formed between the tensioning element and the battery cell, thus enabling a defined heat conduction.

Preferably, the opening has a substantially rectangular basic shape.

It should be noted at this point that, in addition to the arrangement of a thermal compensation element, particularly an adhesive, between the bottom surface of the battery cell and the housing, a further thermal compensation element, particularly an adhesive, can also be arranged between the battery cell and the tensioning element. This ensures a distance between the battery cell and the tensioning element in a simple and cost-efficient manner.

It should further be noted that in one embodiment of the battery module without arrangement of a tensioning strap or tensioning element, the battery cells can preferably be inserted individually into the housing and can subsequently be tensioned by means of tensioning plates of the housing. Here, due to the arrangement of the electrical insulating elements, the battery cells can be easily moved in the longitudinal and transverse directions of the battery module.

It is advantageous if the electrical insulation element is designed as shrink tubing. In particular, ratios between an initial state of the shrink tubing and the shrinkage state of 4:1, 3:1 or 2:1 can be utilized. In particular, a ratio of 2:1 is advantageous. This makes it easy to provide a reliable formation of the electrical insulation element. In particular, the ratio can be adapted to the design of the battery cell in such a way that unimpeded shrinking is possible. The shrink tubing is preferably shrunk by means of heat. This allows a positive-locking connection to be formed between the electrical insulation element in the form of shrink tubing and the battery cell. This can further simplify the handling of the battery cell and the cell stack during assembly due to the positive-locking connection that the electrical insulation element provides to the battery cell in a manner that is secure against loss. In particular, the cell stack can be moved in the longitudinal and transverse directions without losing the electrical insulation elements or causing damage.

At this point, it should be noted that a shrink tubing is attached to each individual battery cell of the battery module. Overall, the heat load on each individual battery cell is comparatively low.

The electrical insulation element and in particular the shrink tubing is preferably chosen such that it has comparatively good sliding properties, a high elongation at break and a high puncture resistance. Furthermore, the shrink tubing can also have additives made of a thermally conductive material. Thanks to its good sliding properties, it is possible for the battery cells and thus also the cell stack to be easily shifted in the housing. Thanks to its high elongation at break, the electrical insulation element can also resist swelling of the respective battery cell. Thanks to its high puncture resistance, the electrical insulation element can resist burn cracks or metallic particles.

Furthermore, the electrical insulation element can also be designed as a deep-drawing film.

It is preferable for the electrical insulation element to be arranged circumferentially around the respective battery cell. This can provide a particularly simple and reliable configuration. In particular, this can also space the individual battery cells apart from one another.

In this case, it is advantageous if the electrical insulation element has a width. The width is at most 25%, preferably at most 10% and in particular at most 5%, of a width of the battery cell. This allows for a reliable arrangement and mechanical attachment and also provides sufficient surface area for a thermal connection. In particular, these values can be limited to a minimum value that is still sufficient for a reliable arrangement, so that sufficient surface area is available for a mechanical and/or thermal connection of the battery cell to the housing of the battery module. In particular, the values are chosen such that when the cell connectors are welded for an electrically conductive serial and/or parallel connection of the battery cells, a permissible surface pressure is present due to a counter-holding force. At this point, it should be noted that the width of the electrical insulation element can also be referred to as the web width. In the case of shrink tubing, the width of the electrical insulation element can be adjusted particularly well by the shrink ratio and the positioning of the heat-shrink tubing on the cell stack.

It is advantageous if the thermal compensation element, and particularly also the additional thermal compensation element, is formed as a thermally conductive adhesive. In particular, such a thermal compensation element or such a thermally conductive adhesive is arranged so that the compensation element or the adhesive is arranged exclusively between the battery cell and the housing or between the battery cell and the tensioning element, and preferably within the respective opening. This provides the particular advantage that the distance between the battery cell and the housing or the distance between the battery cell and the tensioning element is determined solely by the thickness of the electrical insulation element.

Preferably, the thermally conductive adhesive comprises thermally conductive particles. The electrical insulation can be adjusted particularly advantageously by the thickness of the electrical insulation element, independently of the size of the thermally conductive particles. Furthermore, by selecting the thermal conductivity of the adhesive, a potentially required greater thickness of the electrical insulation element can be compensated for.

In particular, the thickness of the shrink tubing is chosen so that both reliable heat dissipation from the battery cells and a reliable mechanical connection are ensured over the service life. Furthermore, the thickness is chosen so that a minimal distance is ensured to ensure electrical insulation between the plurality of battery cells and the housing as well as the tensioning element, even if defects occur on the housing or tensioning element.

Preferably, the battery module housing is designed as a die-cast housing, in particular as an aluminum die-cast housing.

It is useful to place an adhesive between the electrical insulation element and the battery cell. This allows a reliable connection to be formed.

Furthermore, it is advantageous if the electrical insulation element is connected to the battery cell in a positive-locking and/or material-locking manner. This allows a reliable connection to be formed.

### BRIEF DESCRIPTION OF THE DRAWINGS

Exemplary embodiments of the invention are shown in the drawings and explained in more detail in the following description.

Shown are:

FIG. 1 a battery cell of a battery module according to the invention with a first embodiment of electrical insulation elements, each in a perspective view from both the top and bottom,

FIG. 2 a battery cell of a battery module according to the invention with a second embodiment of electrical insulation elements, each in a perspective view from both the top and bottom,

FIG. 3 a perspective view of a cell stack of a battery module according to the invention with electrical insulation elements,

FIG. 4 a further view from below of the cell stack of the battery module according to the invention with electrical insulation elements as shown in FIG. 3,

FIG. 5 a top view of a housing of a battery module according to the invention,

FIG. 6 in a first sectional view of an embodiment of a battery module according to the invention and

FIG. 7 in a second sectional view of an embodiment of a battery module according to the invention.

### DETAILED DESCRIPTION

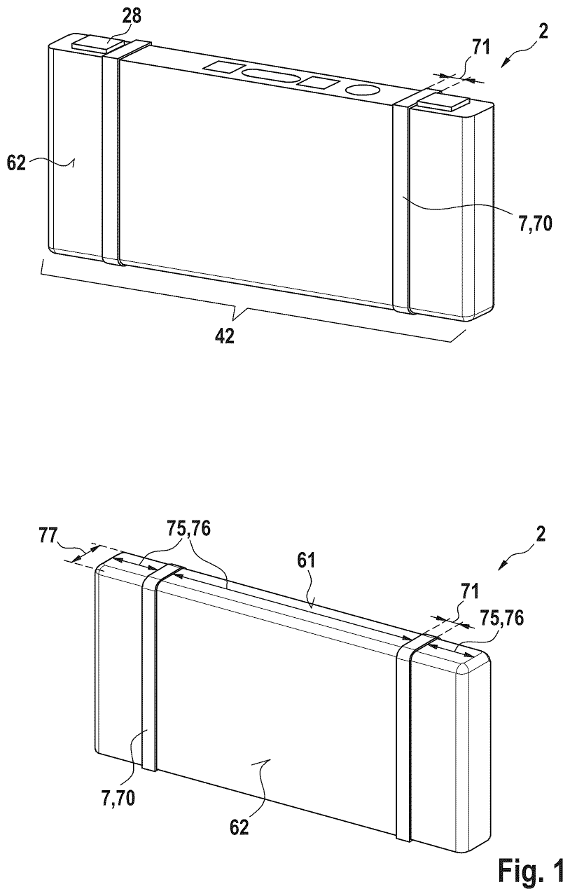

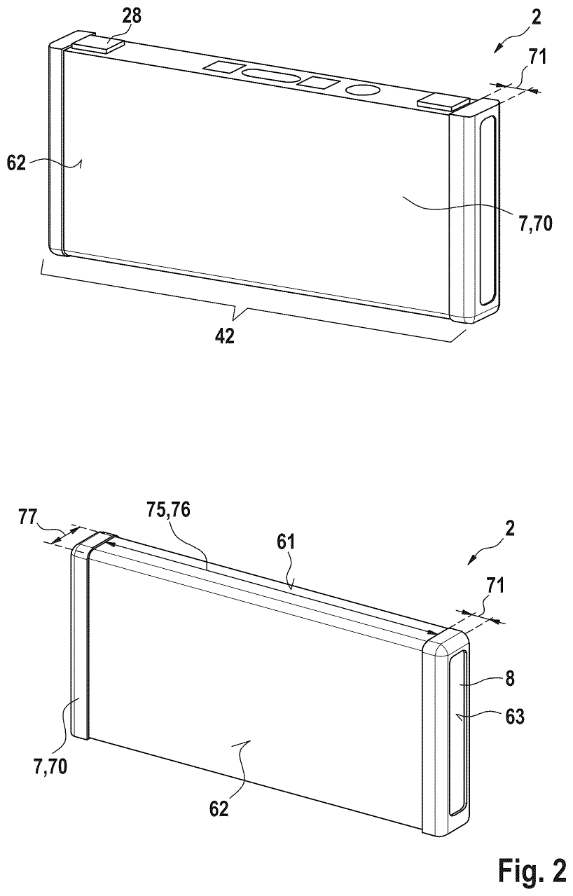

FIG. 1 shows a battery cell 2 of a battery module 1 according to the invention with a first embodiment of electrical insulation elements 7, each in a perspective view from both top and bottom. FIG. 2 shows a battery cell 2 of a battery module 1 according to the invention with a first embodiment of electrical insulation elements 7, each in a perspective view from both top and bottom.

FIGS. 1 and 2 will be described together below.

The battery cell 2 is prismatically formed and has two voltage taps 28, which serve for an electrically conductive connection in parallel and/or series.

The battery cell 2 has two electrical insulation elements 7. These electrical insulation elements 7 are preferably configured as shrink tubing 70 in each case.

The electrical insulation elements 7 are arranged on a bottom surface 61 of the battery cell 2 and are also arranged on the opposite lateral surface 62. In particular, the electrical insulation elements 7 according to FIGS. 1 and 2 are arranged circumferentially around the battery cell 2 in each case.

The electrical insulation elements 7 have a width 71. The width 71 is a maximum of 25%, and more preferably a maximum of 10%, of a width 42 of the respective battery cell 2.

In contrast to FIG. 2, in the embodiment according to FIG. 1, the electrical insulation elements 7 are arranged between the voltage taps 28. This results in a total of three connection surfaces 75 for a mechanical and thermal connection of the battery cell 2 to the housing 3, each having a length 76 and a width 77.

In contrast to FIG. 1, in the embodiment according to FIG. 2, the electrical insulation elements 7 are further arranged on an additional lateral surface 63 of the battery cell 2, so that the respective electrical insulation element 7 can be arranged between the battery cell 2 and a tensioning element 40 of the battery module 1. This results in a total of only one connection surface 75 for a mechanical and thermal connection of the battery cell 2 to the housing 3, which has a length 76 and a width 77.

Furthermore, the electrical insulation elements 7 according to FIG. 2 each comprise an opening 8 in which an additional thermal compensation material 90, which cannot be seen in FIG. 2, can be arranged between the battery cell 2 and the tensioning element 40 of the battery module 1.

The opening 8 is essentially rectangular.

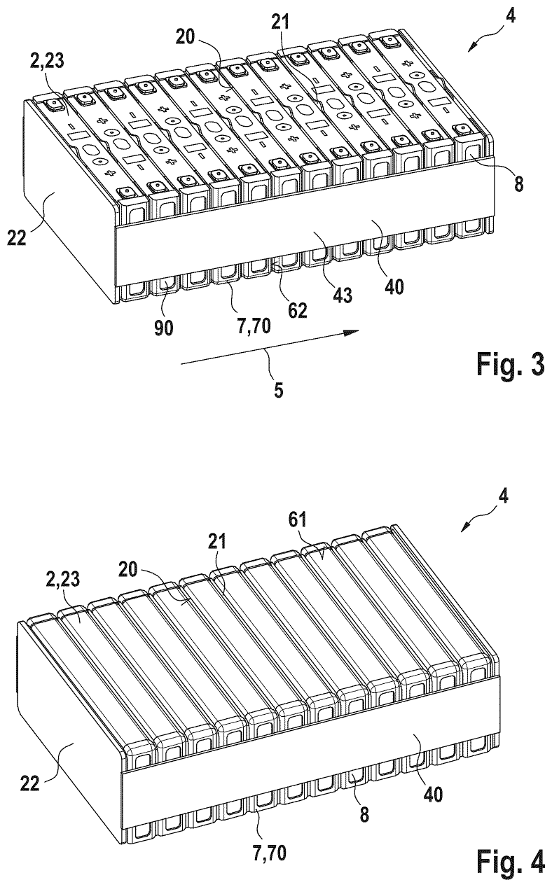

FIG. 3 shows a cell stack 4 of a battery module 1 with electrical insulation elements 7 in a perspective view, and FIG. 4 shows the cell stack 4 of the battery module 1 with electrical insulation elements 7 in a further view from below, according to FIG. 1.

FIGS. 3 and 4 are described together below.

In FIGS. 3 and 4, a plurality of battery cells 2 can be seen in each case, which are prismatically formed and which together form the cell stack 4. Furthermore, such a cell stack 4 can be received in a housing 3 of the battery module 1, which cannot be seen in FIGS. 3 and 4.

The plurality of battery cells 2 are arranged with their largest lateral surfaces 20 adjacent to one another in a longitudinal direction 5 of the battery module 1.

A spacer element 21 can be arranged between each two neighboring battery cells 2. The battery cells 2 are arranged between two end plates 22, so that a terminal battery cell 23 is arranged adjacent to an end plate 22. The plurality of battery cells 2 are clamped to one another in accordance with the embodiment shown in FIGS. 3 and 4. For this purpose, the battery module 1 can have tensioning straps 40 which are arranged on the longitudinal sides 43 of the cell stack 4 and are connected in a material-locking manner to the end plates 22. It should be noted at this point that embodiments can also be designed without the arrangement of tensioning straps 40.

An electrical insulation element 7 is partially arranged on a bottom surface 61 of a battery cell 2 as well as on opposite lateral surfaces 62 of a battery cell 2. The electrical insulation element 7 is ultimately arranged between the battery cells 2 or the cell stack 4 and the housing 3 of the battery module 1.

An additional thermal compensation material 90 can be arranged in an opening 8 between the tensioning element 4 and a battery cell 2.

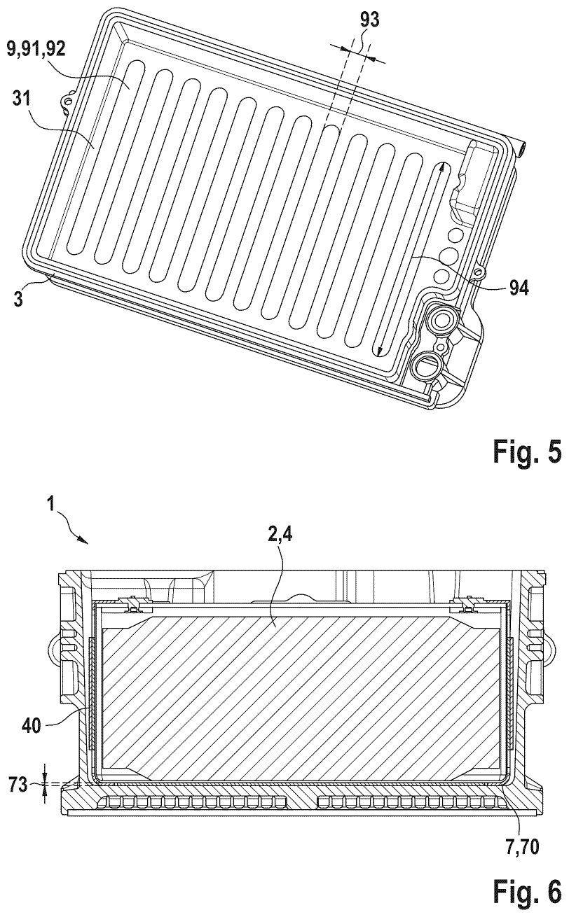

FIG. 5 shows a top view of a housing 3 of a battery module 1 according to the invention. The cell stack 4 can be accommodated in such a housing 3. At this point, it should be noted that in the representation according to FIG. 5, the cell stack 4 is not accommodated in the housing 3.

In particular, a housing base 31 can be seen, which, in an arrangement of the cell stack 4, is arranged directly adjacent to the bottom surface 61 of the respective battery cell 2.

Furthermore, FIG. 5 shows the application of a thermal balancing element 9. This thermal balancing element 9 is designed as a thermally conductive adhesive 91.

The adhesive 91 is applied in the form of adhesive beads 92. These adhesive beads 92 have a length 93 and a width 94. The length 93 and the width 94 of the adhesive beads 92 are selected such that, after the cell stack 4 has been arranged in the housing 3, the thermally conductive adhesive 91 does not come into contact with the electrical insulation elements 7.

Furthermore, the thermal balancing element 9 or the thermally conductive adhesive 91 can be arranged over a large area between the battery cells 2 or the cell stack 4 and the housing 3.

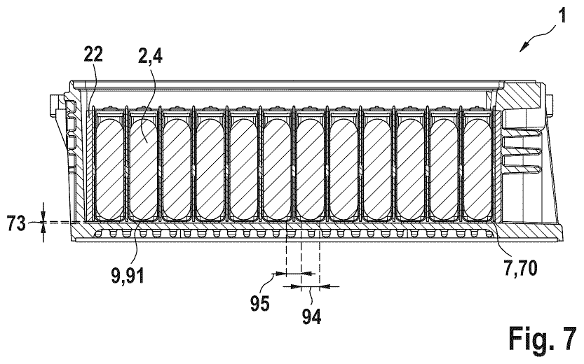

FIG. 6 shows an embodiment of a battery module 1 according to the invention in a first sectional view and FIG. 7 shows an embodiment of a battery module 1 according to the invention in a second sectional view.

FIGS. 6 and 7 are described together below.

First, the cell stack 4 with the prismatically formed battery cells 2 can be seen. Furthermore, the end plates 22 and the tensioning straps 40 can be seen.

Moreover, the electrical insulation elements 7, which are each designed as shrink tubing 70, can be seen in FIGS. 6 and 7. The thickness 73 of the electrical insulation element 7 can also be seen in FIGS. 6 and 7.

FIG. 7 also shows the width 94 of the adhesive beads 92. which are spaced apart from one another by a distance 95.

1. A battery module comprising a plurality of prismatically configured battery cells (2), which together form a cell stack (4), and which are accommodated in a housing (3) of the battery module (1), wherein an electrical insulation element (7) is arranged on a battery cell (2) at least on a bottom surface (61) of the battery cell (2) and partially on opposite lateral surfaces (62) of the battery cell (2) in such a way that the electrical insulation element (7) is arranged between the respective battery cell (2) and the housing (3), as well as between the respective battery cell (2) and battery cells (26) adjacent to the battery cell (2), wherein a thermal compensation material (9) is arranged between the battery cell (2) and the housing (3).

2. The battery module according to claim 1, wherein the plurality of battery cells (2) are arranged adjacent to each other with respective largest lateral surfaces (20) in a longitudinal direction (5) of the battery module (1), wherein the plurality of battery cells (2) are tensioned together.

3. The battery module according to claim 2, wherein the electrical insulation element (7) is further arranged on a further lateral surface (63) of the battery cell (2) in such a way that the electrical insulation element (7) is arranged between the battery cell (2) and a tensioning element (40) of the battery module (1).

4. The battery module according to claim 3, wherein the electrical insulation element (7) comprises an opening (8), wherein a further thermal compensation element (90) is arranged in the opening (8) between the battery cell (2) and the tensioning element (40).

5. The battery module according to claim 1, wherein the electrical insulation element (7) is formed as shrink tubing (70).

6. The battery module according to claim 1, wherein the electrical insulation element (7) is arranged circumferentially around the respective battery cell (2).

7. The battery module according to claim 6, wherein the electrical insulation element (7) has a width (71), wherein the width (71) is at most 25% of a width (42) of the battery cell (2).

8. The battery module according to claim 1, wherein the thermal compensation element (9) is configured as a thermally conductive adhesive (91).

9. The battery module according to claim 1, wherein the housing (3) is configured as a die-cast housing (31).

10. The battery module according to claim 1, wherein an adhesive is arranged between the electrical insulation element (7) and the battery cell (2).

11. The battery module according to claim 1, wherein the electrical insulation element (7) is connected to the battery cell (2) in a positive-locking and/or material-locking manner.

12. The battery module according to claim 9, wherein the housing (3) is configured as an aluminum die-cast housing (32).
